(19) United States
(12) Patent Application Publication
(10) Pub. No.: US 2005/0094605 A1
(43) Pub. Date: May 5, 2005

(54) TDD-based method for transmitting high-speed data

(76) Inventors: Lixin Sun, Shenzhen (CN); Lei Zhou, Shenzhen (CN)

Correspondence Address: Shemwell Gregory & Courtney LLP, Suite 201, 4880 Stevens Creek Blvd., San Jose, CA, 95129, US

(21) Appl. No.: 10/956,380

(22) Filed: Oct. 1, 2004

(30) Foreign Application Priority Data
Jan. 27, 2003 (WO) PCT/CN03/00076
Apr. 3, 2002 (CN) 02116534.3

(51) Int. Cl. H04J 3/00

(52) U.S. Cl. 370/337; 370/347; 370/458

(57) ABSTRACT

Embodiments of the present invention include a TDD-based method for transmitting high-speed data, comprising: first, time slices for uplink sending and downlink sending are allocated in a time frame respectively; second, synchronization time slot for uplink synchronization and synchronization time slot for downlink synchronization, control time slot for transmitting uplink signaling and control time slot for transmitting downlink signaling, as well as several traffic time slots for transmitting high-speed data services are allocated respectively; third, different traffic time slots are configured with different time spans; next, traffic time slots of appropriate time spans are allocated for different users as required for service data transmission; finally, data services are transmitted; with above solution, longer time slots can be allocated for users with higher service levels or better transmission conditions; therefore, embodiments of the present invention can improve data transmission efficiency and spectrum utilization efficiency, and reduce data transmission costs.

### RELATED APPLICATIONS

This application claims priority from Patent Cooperation Treat (PCT) Application No. PCT/CN03/00076, filed Jan. 27, 2003, which claims priority from Chinese Patent Application No. 02116534.3, filed Apr. 3, 2002.

### FIELD OF THE INVENTION

The present invention relates to a TDD-based (Time Division Duplex-based) method for transmitting traffic in wireless communication systems, particularly to a method for transmitting high-speed data.

### BACKGROUND OF THE INVENTION

In today's TDD-based 3G wireless communication systems, such as TD-SCDMA systems, traffic is usually transmitted with the following method: 96-code slice DwPTS (Downlink Pilot Time Slot) is utilized to implement downlink receiving synchronization; UpPTS (Uplink Pilot Time Slot) with 96-code slice GP (Guard Period) is utilized to implement uplink receiving synchronization; finally, traffic time slots of the same time spans are utilized to provide traffic transmission for different users. The time slot structure employed in the above method is shown in FIG. 1, which illustrates the time slot structure of a 5 ms sub-frame in TD-SCDMA. In FIG. 1, besides three special time slots (DwPTS, GP, and UpPTS) for synchronization, all of the remaining 7 traffic time slots (including two uplink time slots (TS1 and TS2) and 5 downlink time slots (TSO, TS3, TS4, TS5, and TS6)) last 0.675 ms respectively. The fixed-time span time slot frame structure shown in FIG. 1 is adapted to voice services that require high real-time performance and low transmission rate; with the above time slot structure, the conventional method can usually ensure available appropriate resources for voice services at any time. However, such a method is not applicable to data services that require low real-time performance with a variable transmission rate.

One of the reasons the above-described method is not applicable to data services is that in actual traffic transmission, due to the affect of radio fade in the transmission channel, as well as different user distances to the base station in a cell, the maximum data transmission rate that can be received normally by a user terminal is different in a cell. The document CDMA/HDR: A bandwidth-efficient high-speed wireless data service for nomadic users (P Bender, P Black, M Grob, R Padovani N Sindhushayana and Andrew Viterbi, IEEE Commun Mag, Jul., 2000: 70 ˜77) provides a statistical result of different maximum data transmission rates supported in a cell, from which the above fact can be seen. Referring to FIG. 2, the horizontal ordinate in FIG. 2 represents the supported maximum data transmission rates (unit: KB/s); the vertical coordinate represents the probability of the case in which the user terminal is at a certain transmission rate. Alternatively, it can be understood as the percentage of the user terminals supporting a certain data transmission rate to all user terminals. It is seen from FIG. 2 that the data transmission rate supported by a user terminal is variable. When the conventional method is used to transmit data of different users, high-speed user terminals have to wait due to the limited time slot length after a segment of data is transmitted quickly (remembering that data is transmitted in time slots of the same length). Low speeduser terminals are also allocated time slots of the same length. Since the conventional method doesn't utilize the features that the transmission rates of different user data services are different and data services don't require high real-time performance, along with limitation of channel condition and other conditions, certain frequency spectrum efficiency loss is inevitable in data service transmission. This results in wasted resources; therefore, the communication has to be carried out at a extremely low rate. In addition, the time slot structure employed in the conventional method is independent, i.e., each time slot is configured with a separate pilot signal. For customers demanding high data rates, high-speed data communication can only be implemented through allocating more time slots. Therefore duplicated pilot signals can not be used to transmit service data, resulting in a substantial waste of time, and having other adverse affects on high-speed data transmission.

### SUMMARY OF THE INVENTION

An object of the present invention is to provide an efficient TDD-based method for transmitting high-speed data, which improves transmission rate and spectrum utilization and reduces operating costs.

To attain said object, the TDD-based method for transmitting high-speed data comprises:
(1) allocating time slices for uplink sending and downlink sending in a time frame, respectively;
(2) in uplink sending time slice and downlink sending time slice, allocating a synchronization time slot for uplink synchronization and a synchronization time slot for downlink synchronization, a control time slot for transmitting uplink signaling and a control time slot for transmitting downlink signaling, and a plurality of traffic time slots for transmitting high-speed data, respectively;
(3) setting different traffic time slots to last different time spans;
(4) allocating traffic time slots lasting different time spans for users, and then transmitting the data.

Said synchronization time slot, control time slot, and traffic time slots in step (2) are not overlapped in time.

Said synchronization time slot for uplink synchronization and said synchronization time slot for downlink synchronization in step (2) may be one or more as required, respectively.

Said control time slot for transmitting uplink signaling and said control time slot for downlink signaling in step (2) may be one or more as required, respectively.

In step (4), traffic time slots lasting corresponding time spans can be allocated for users according to measured user channel condition, according to specified QoS (Quality of Service) condition, or according to both.

Since the present invention employs a variable-length time slot structure, the communications system can provide services at different data rates in the same frame (sub-frame). Compared to the conventional data transmission method, the number of code slices for a service data is specified because the service data transmission time span of a time slot is specific; therefore, the number of data bits that are transmitted in a frame (sub-frame) is specific, so that different user demands can be met. For example, when there are users with different service levels, the requirement for high-speed data transmission can be met through allocating longer time slots for users with higher service levels. When there is only one service level, longer time slots can be allocated and data transmission modes with higher data rate (e.g., high order modulation) can be used for users with better channel condition, so that more bits can be transmitted in the same time period, in order to improve frequency spectrum efficiency and reduce operating costs. It is seen from the above description that the present invention meets the requirements of data transmissions of different service levels in an efficient and easy to implement manner.

### BRIEF DESCRIPTION OF THE DRAWINGS

FIG. 1 illustrates a fixed-time span time slot frame structure used in a conventional, prior art method.

FIG. 2 is a statistical chart of user terminals supporting different maximum data transmission efficiencies in a cell, according to prior art methods.

FIG. 3 is a flow chart illustrating a method of the present invention according to an embodiment.

FIG. 4 is a schematic diagram of a variable-time span time slot frame structure that is applied to the embodiment shown in FIG. 3.

### DETAILED DESCRIPTION OF THE EMBODIMENTS

In a cellular wireless communication system, mobile users are usually distributed at different locations in a cell. The maximum data transmission rate that can be received normally by a user terminal in the cell is specific due to radio fade. On the premise of meeting required transmission error rate, the difference among maximum data transmission rates supported by most user terminals is not significant. However, the channel condition of some user terminals are better and support higher data transmission rates; while the channel condition of some other users are worse and can only support lower data transmission rates. Though the system capacity can be improved through reducing waiting time of user terminals supporting higher transmission rates, there is limitation on ratio of maximum waiting time/minimum waiting time in actual applications. To solve above problem, the present invention utilizes the fact that data services have no demanding requirement for real-time transmission to optimize frequency spectrum resources, i.e., more time slots are allocated to users with better channel conditions in order to improve system capacity.

Hereunder the present invention is detailed with reference to the attached drawings.

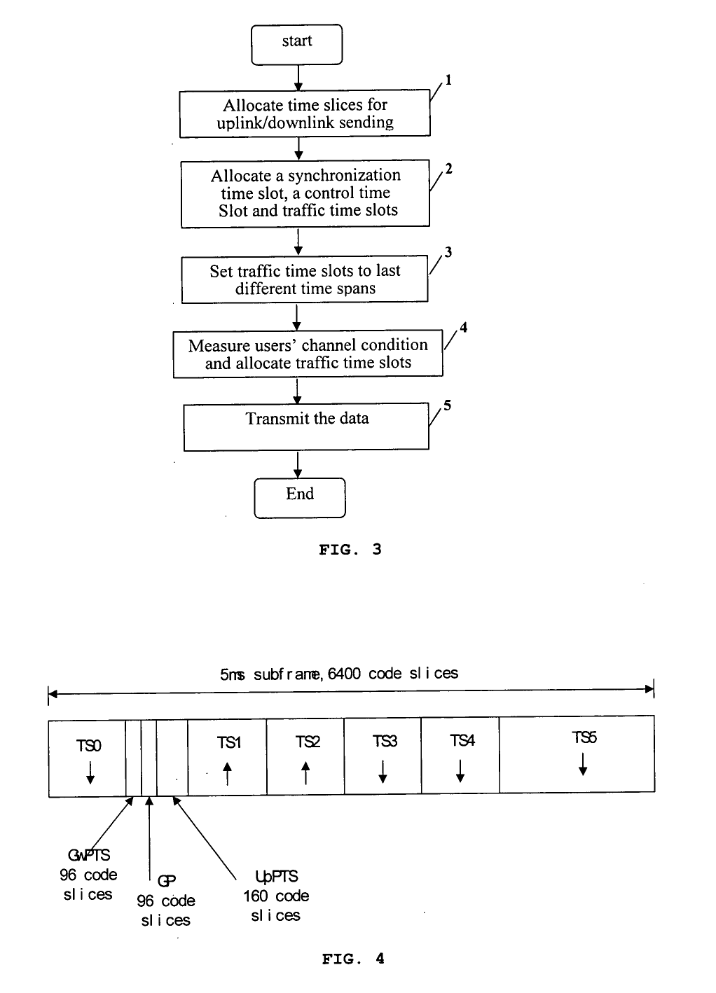

FIG. 3 is a flow chart of an embodiment implemented with the method described in the present invention. As shown in FIG. 3, the present invention determines the data structure in a time frame for data transmission first and utilizes the data structure to transmit service data then. In detail, in step 1, time slices are allocated for uplink sending and downlink sending are allocated in a time frame respectively; one purpose of the step is to set the uplink/downlink time slice in a proportion suitable for actual service data transmission according to characteristics of uplink/downlink services. Since control (e.g., synchronization) is required for uplink/downlink transmission of service data, the following time slots are all allocated for uplink sending and downlink sending in step 2: synchronization time slot for uplink synchronization and synchronization time slot for downlink synchronization; control time slot for transmitting uplink signaling and control time slot for downlink signaling; and several traffic time slots for transmitting high-speed data services. Although both the synchronization time slot for uplink synchronization and the synchronization time slot for downlink synchronization are one time slot in the present embodiment, several time slots can be allocated as required in actual applications. Similarly, though both the control time slot for transmitting uplink signaling and the control time slot for transmitting downlink signaling are one time slot in the present embodiment, more time slots may be allocated as required in actual applications.

Since broadband TDD frames are relatively long (e.g., 10ms) in broadband applications and the code slice rate is 3 times of that of TD-SCDMA applications, it is difficult to implement synchronization; therefore, several synchronization time slots may be required. That is to say, if the time frame is long, several synchronization time slots can facilitate synchronization. Similarly, in the case of long time frame, several times of transmission control signaling may be required; therefore several control time slots may be necessary.

The above synchronization time slots, control time slots, and traffic time slots are not overlapped with each other in time. One purpose for this is to reduce mutual interference among synchronization data, control data, and service data.

Next, in step 3, different traffic time slots are set with different time spans to adapt to transmission demands of different service data.

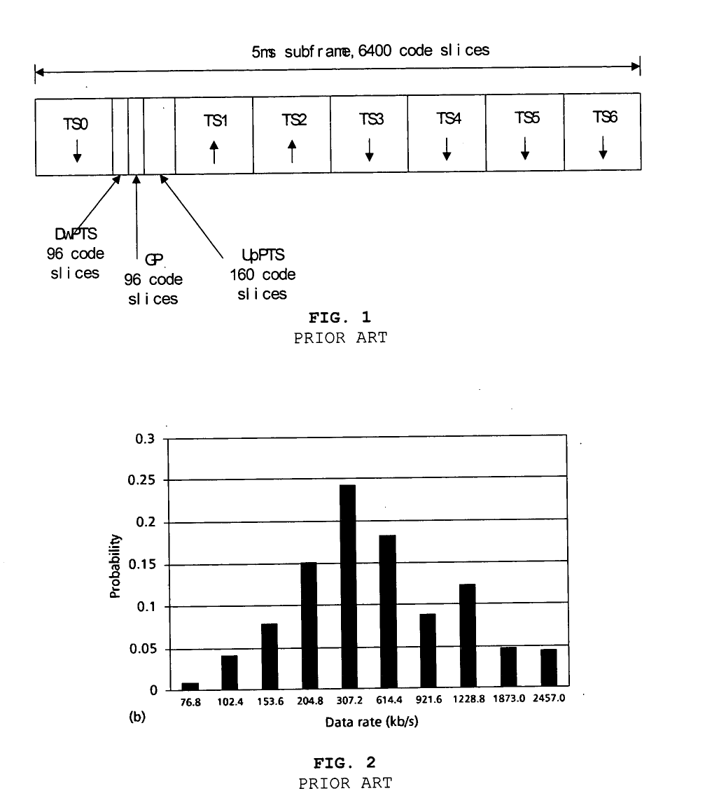

FIG.4 is a schematic diagram of the variable-time span time slot frame structure that is applied to the embodiment shown in FIG. 3. Through comparing the time slot structure in FIG.4 with the time slot structure in FIG.1, we can see that the last two time slots are combined into one time slot. Therefore, the original two pilot signals can be combined into one pilot signal, so that a pilot signal can be released for data transmission. In an environment with different service levels, the last time slot (TS5 in FIG. 4) can provide more code slice resources for high-speed data service users to transmit service data. In addition, through allocating TS5 to a user with better channel condition, a transmission mode with higher efficiency (e.g., high order modulation) can be applied for transmission in entire TS5 time slot, so that the base station can issue more bits in the same time period; thus the system throughput is improved. Furthermore, long time slots can also improve coding efficiency (e.g., Turbo coding).

The users' channel conditions are tested in step 4 (referring again to FIG. 3) during service data transmission, and traffic time slots of appropriate time spans are allocated for different users according to tested channel conditions. Finally, the users' data are transmitted in step 5. It is noted that traffic time slots of appropriate time spans can also be allocated for different users according to specified QoS condition or combinations of measured user channel condition and specified QoS condition.

1. A TDD-based (Time Division Duplex-based) method for transmitting high-speed data, comprising:
(1) allocating time slices for uplink sending and downlink sending in a time frame, respectively;
(2) in uplink sending time slice and downlink sending time slice, allocating a synchronization time slot for uplink synchronization and a synchronization time slot for downlink synchronization, a control time slot for transmitting uplink signaling and a control time slot for transmitting downlink signaling, and a plurality of traffic time slots for transmitting high-speed data, respectively;
(3) setting different traffic time slots to last different time spans;
(4) allocating traffic time slots lasting different time spans for users, and then transmitting the data.

2. A TDD-based method for transmitting high-speed data according to claim 1, wherein said step (2) of allocating said synchronization time slot, said control time slot, and the plurality of traffic time slots refers to allocating one synchronization time slot, one control time slot, and a plurality of traffic time slots which are not overlapped in time.

3. A TDD-based method for transmitting high-speed data according to claim 2, wherein said step (2) of allocating said synchronization time slot for uplink synchronization and said synchronization time slot for downlink synchronization refers to allocating one synchronization time slot for uplink synchronization and one synchronization time slot for downlink synchronization.

4. A TDD-based method for transmitting high-speed data according to claim 2, wherein said step (2) of allocating said synchronization time slot for uplink synchronization and said synchronization time slot for downlink synchronization refers to allocating a plurality of synchronization time slots for uplink synchronization and a plurality of synchronization time slots for downlink synchronization.

5. A TDD-based method for transmitting high-speed data according to claim 2, wherein said step (2) of allocating said control time slot for transmitting uplink signaling refers to allocate one control time slot for transmitting uplink signaling.

6. A TDD-based method for transmitting high-speed data according to claim 2, wherein said step (2) of allocating said control time slot for transmitting downlink signaling refers to allocate one control time slot for transmitting downlink signaling.

7. A TDD-based method for transmitting high-speed data according to claim 2, wherein said step (2) of allocating said control time slot for transmitting uplink signaling and said control time slot for transmitting downlink signaling refers to allocate a plurality of control time slots for transmitting uplink signaling and a plurality of control time slots for transmitting downlink signaling.

8. A TDD-based method for transmitting high-speed data according to claim 2, wherein instep (4), the traffic time slots lasting corresponding time spans are allocated for users according to the measured user channel condition.

9. A TDD-based method for transmitting high-speed data according to claim 2, wherein in step (4), the traffic time slots lasting corresponding time spans are allocated for users according to specified QoS (Quality of Service) condition.

10. A TDD-based method for transmitting high-speed data according to claim 2, in step (4), the traffic time slots lasting corresponding time spans are allocated for users according to both of the measured user channel condition and the specified QoS condition.
